(19) United States
(12) Patent Application Publication
(10) Pub. No.: US 2010/0248741 A1
(43) Pub. Date: Sep. 30, 2010

(54) METHOD AND APPARATUS FOR ILLUSTRATIVE REPRESENTATION OF A TEXT COMMUNICATION

(75) Inventors: Vidya Setlur, Cupertino, CA (US); Timothy Youngjin Sohn, Mountain View, CA (US); Agathe Battestini, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/414,603

(22) Filed: Mar. 30, 2009

(51) Int. Cl. H04W 64/00

(52) U.S. Cl. 455/456.1

(57) ABSTRACT

In accordance with an example embodiment of the present invention, a method comprises receiving a text communication using a mobile electronic device, receiving location information and generating an illustrative representation of said text communication utilizing the text communication and the location information and displaying the illustrative representation. In accordance with an another example embodiment of the present invention, an apparatus comprises a network interface for receiving a text communication, a location determining unit, at least one sensor, and a processor communicatively coupled with the network interface, the location determining unit and the at least one sensor; the processor configured to generate an illustrative representation of the text communication, and a display configured to display the illustrative representation.

### TECHNICAL FIELD

The present application relates generally to a method and apparatus for generating an illustrative representation of a text communication and more specifically to a method and apparatus for generating an illustrative representation of a text communication using a mobile electronic device.

### BACKGROUND

Text communication among mobile electronic device users including email messages, instant messages and text messages has gained significant popularity especially in recent years. Users of mobile electronic devices such as mobile phones and personal digital assistants (PDAs) communicate with each other in convenient, secure and entertaining ways. Mobile electronic device applications such as mobile web browsers, mobile chat applications and mobile email clients allow mobile electronic device users to interact with each other online furthering their personal and professional relationships.

### SUMMARY

Various aspects of the invention are set out in the claims.

According to a first aspect of the present invention, a method comprises receiving a text communication using a mobile electronic device, receiving location information, generating an illustrative representation of the text communication utilizing the text communication and the location information, and displaying the illustrative representation.

According to a second aspect of the present invention, a method comprises creating a text communication using a mobile electronic device, determining a present geographic location using a location determining unit on the mobile electronic device, receiving sensor information, generating an illustrative representation of the text communication utilizing the sensor information and the present geographic location, and transmitting the illustrative representation to a remote mobile electronic device.

According to a third aspect of the present invention, an apparatus comprises a network interface for receiving a text communication, location determining unit, at least one sensor, a processor communicatively coupled with the network interface, the location determining unit and the at least one sensor; the processor configured to generate an illustrative representation of the text communication.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram of a mobile electronic device communication environment according to an example embodiment of the invention;

FIG. 2 is a block diagram depicting a mobile electronic device operating according to an example embodiment of the invention;

FIG. 3 is a flow diagram illustrating a method for generating and displaying an illustrative representation of a text communication according to an example embodiment of the invention;

FIG. 4A is a screen view showing a layout of an illustrative representation of a text communication according to an example embodiment of the invention;

FIG. 4B is a screen view showing an illustrative representation of a text communication as rendered by a processor according to an example embodiment of the invention;

FIG. 4C is a screen view showing an illustrative representation of a text communication as rendered by a processor indicating movement of a text communication participant according to an example embodiment of the invention;

FIG. 4D is a screen view showing an illustrative representation of a text communication as rendered by a processor showing that a text communication participant is travelling in an automobile according to an example embodiment of the invention; and

FIG. 5 is a flow diagram illustrating a method for generating and transmitting an illustrative representation of a text communication according to an example embodiment of the invention.

### DETAILED DESCRIPTION OF THE DRAWINGS

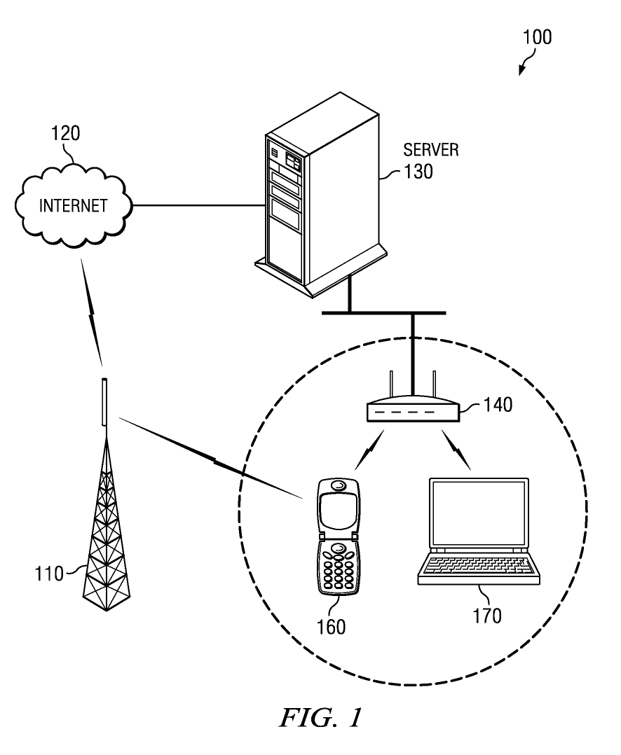

FIG. 1 is a block diagram of a mobile electronic device communication environment according to an example embodiment of the invention. The mobile electronic device communication environment 100 provides connectivity over a wired local area network (LAN), a Wireless Local Area Network (WLAN) or a radio frequency (RF) communications network. Communications within communication environment 100 may be provided using a wired or wireless communications network utilizing any appropriate protocol, for example TCP/IP, HTTP and/or the like. In an example embodiment, a mobile electronic device such as mobile electronic device 160 communicates with a base station 110 utilizing a mobile communication protocol such as GSM, CDMA and/or the like. The base station 110 provides Internet access to mobile electronic device 160 over a packet switched network. Application services and content are provided via the Internet to mobile electronic device 160. The mobile electronic device 160 may connect with server 130 over the network and with other mobile electronic devices such as laptop 170 to transmit and receive data including content such as email, text messages multimedia messages, web pages and/or the like. Servers on the network such as server 130 host application services such as email, chat, Short Message Service (SMS), Multi-media Messaging Service (MMS) and/or the like.

The mobile electronic device 160 may also access the Internet and/or server 130 using a WLAN. WLANs may provide access to communications environment 100 provided that a mobile electronic device such as mobile electronic device 160 or laptop 170 is within range. The mobile electronic device 160 may communicate with other mobile electronic devices such as laptop 170 within range of access point 140. An access point such as access point 140 may implement a variety of standardized technologies such as 802.11b, 802.11g or 802.11n WLAN protocols. In an example embodiment, mobile electronic device 160 transmits and receives communication data such as text communication (e.g. text messages, instant messages, email messages, multimedia messages and/other the like with laptop 170 or other mobile electronic devices via WLAN that may be in range of access point 140. In another example embodiment, mobile electronic device 160 may communicate directly with other mobile electronic devices without a WLAN using a direct connection or an ad hoc connection.

Text communication may include an illustrative representation of a text communication. In an example embodiment, an illustrative representation of a text communication may comprise an image or other visual representation of a text communication participant who may be sending or receiving a text communication. An illustrative representation of a text communication may also comprise a visual representation of a least one location, which may include the location of a text communication participant. An illustrative representation of a text communication may also comprise a visual representation of one or more subject matters of the text communication. Further, an illustrative representation of a text communication may be generated utilizing sensor information or other context information. Sensor information may originate from a mobile electronic device such as mobile electronic device 160. Context information may include, for example, time information at a particular location.

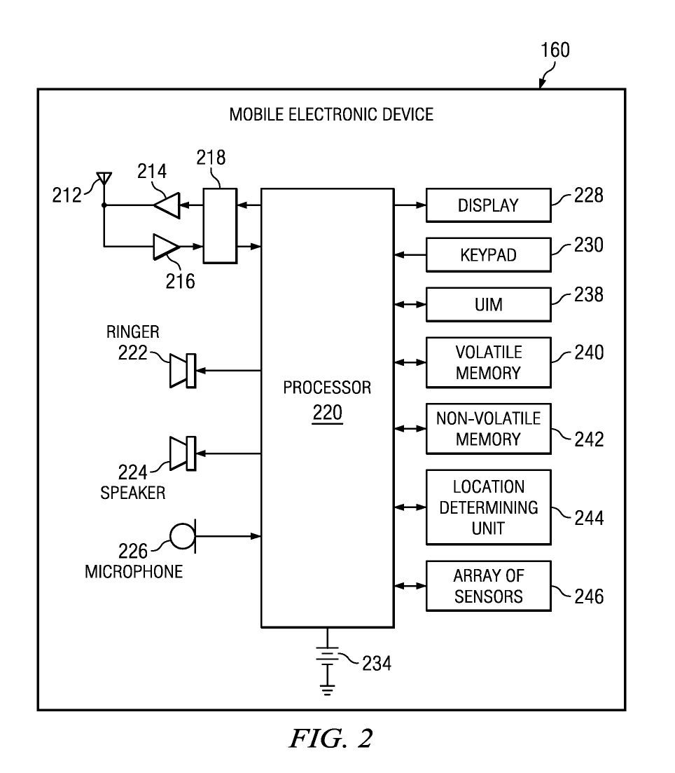

FIG. 2 is a block diagram depicting a mobile electronic device operating in accordance with an example embodiment of the invention. In FIG. 2, a mobile electronic device such as mobile electronic device 160 comprises at least one antenna 212 in communication with a transmitter 214 and a receiver 216. Transmitter 214 and/or receiver 216 is connected with a network interface for such as network interface 218 for transmitting and receiving text communication. The mobile electronic device 160 comprises a processor 220 and/or one or more other processing components. The processor 220 provides at least one signal to the transmitter 214 and receives at least one signal from the receiver 216. Mobile electronic device 160 also comprises a user interface that includes one or more input and/or output devices, such as a conventional earphone or speaker 224, a ringer 222, a microphone 226, a display 228, a keypad 230 and/or the like. Input and output devices of the user interface are coupled with processor 220. In an example embodiment, the display 228 may be a touch screen, liquid crystal display, and/or the like capable of displaying text communications and illustrative representations of text communications. Keypad 230 may be used to compose text communications and provide other input to mobile electronic device 160.

In an example embodiment, the mobile electronic device 160 also comprises a battery 234, such as a vibrating battery pack for powering various circuits to operate mobile electronic device 160. Mobile electronic device 160 further comprises a location determining unit such as location determining unit 244. Location determining unit 244 may comprise a Global Positioning System (GPS) receiver for receiving a present geographic location of mobile electronic device 160. Mobile electronic device 160 further comprises a user identity module (UIM) 238. For example, UIM 238 may be a memory device comprising a processor. The UIM 238 may comprise, for example, a subscriber identity module (SIM), a universal integrated circuit card (UICC), a universal subscriber identity module (USIM), a removable user identity module (R-UIM), and/or the like. Further, the UIM 238 may store one or more information elements related to a subscriber, such as a mobile subscriber. Mobile electronic device 160 comprises an array of sensors 246. Array of sensors 246 may comprise one or more sensors each of any type including but not limited to motion sensors such as an accelerometer or a rotation sensor, light sensors such as a sun light sensor, environmental sensors such as a temperature sensor or barometer and/or the like. In an example embodiment, an accelerometer is a device used to measure motion and/or acceleration in a mobile electronic device. In another example embodiment, a rotation sensor is a device used to measure rotational motion in a mobile electronic device.

The mobile electronic device 160 comprises volatile memory 240, such as random access memory (RAM). Volatile memory 240 may comprise a cache area for the temporary storage of data. Further, the mobile electronic device 160 comprises non-volatile memory 242, which may be embedded and/or removable. The non-volatile memory 242 may also comprise an electrically erasable programmable read only memory (EEPROM), flash memory, and/or the like. In an embodiment, mobile electronic device 160 may use memory to store any of a number of pieces of information and/or data to implement one or more features of the mobile electronic device 160. Further, the memory may comprise an identifier, such as international mobile equipment identification (IMEI) code, capable of uniquely identifying the mobile electronic device 160. The memory may store one or more instructions for determining cellular identification information based at least in part on the identifier. For example, the processor 220, using the stored instructions, may determine an identity, e.g., using cell identification information. Location determining unit 244 may use cell identification information to determine a geographic location for mobile electronic device 160.

Processor 220 of mobile electronic device 160 may comprise circuitry for implementing audio features, logic features, and/or the like. For example, the processor 220 may comprise a digital signal processor device, a microprocessor device, a digital to analog converter, other support circuits, and/or the like. Further, the processor 220 may comprise features to operate one or more software programs. For example, the processor 220 may be capable of operating a software program for connectivity, such as a conventional Internet browser. Further, the connectivity program may allow the mobile electronic device 160 to transmit and receive Internet content, such as email messages, text messages, SMS messages, MMS messages, location-based content, web page content, and/or the like. Further, processor 220 is capable of executing a software program for generating an illustrative representation of a text communication. Display 228 is capable of displaying illustrative representations of text communications.

In an example embodiment, the mobile electronic device 160 is capable of operating in accordance with any of a number of a first generation communication protocol, a second generation communication protocol, a third generation communication protocol, a fourth generation communication protocol, and/or the like. For example, the mobile electronic device 160 may be capable of operating in accordance with second generation (2G) communication protocols IS-136, time division multiple access (TDMA), global system for mobile communication (GSM), IS-95 code division multiple access (CDMA), and/or the like. Further, the mobile electronic device 160 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the mobile electronic device 160 may also be capable of operating in accordance with 3.9 generation (3.9G) wireless communication protocols, such as Evolved Universal Terrestrial Radio Access Network (E-UTRAN) and/or the like, or wireless communication projects, such as long term evolution (LTE) and/or the like. Still further, the mobile electronic device 160 may be capable of operating in accordance with fourth generation (4G) communication protocols.

In an example embodiment, mobile electronic device 160 is capable of operating in accordance with a non-cellular communication mechanism. For example, mobile electronic device 160 may be capable of communication in a wireless local area network (WLAN), other communication networks, and/or the like. Further, the mobile electronic device 160 may communicate in accordance with techniques, such as radio frequency (RF), infrared (IrDA), any of a number of WLAN techniques. For example, the mobile electronic device 160 may communicate using one or more of the following WLAN techniques: IEEE 802.11, e.g., 802.11a, 802.11b, 802.11g, 802.11n, and/or the like.

While embodiments of the mobile electronic device 160 are illustrated and will be hereinafter described for purposes of example, other types of mobile electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by mobile electronic device 160, embodiments may also be employed by a server, a service, a combination thereof, and/or the like.

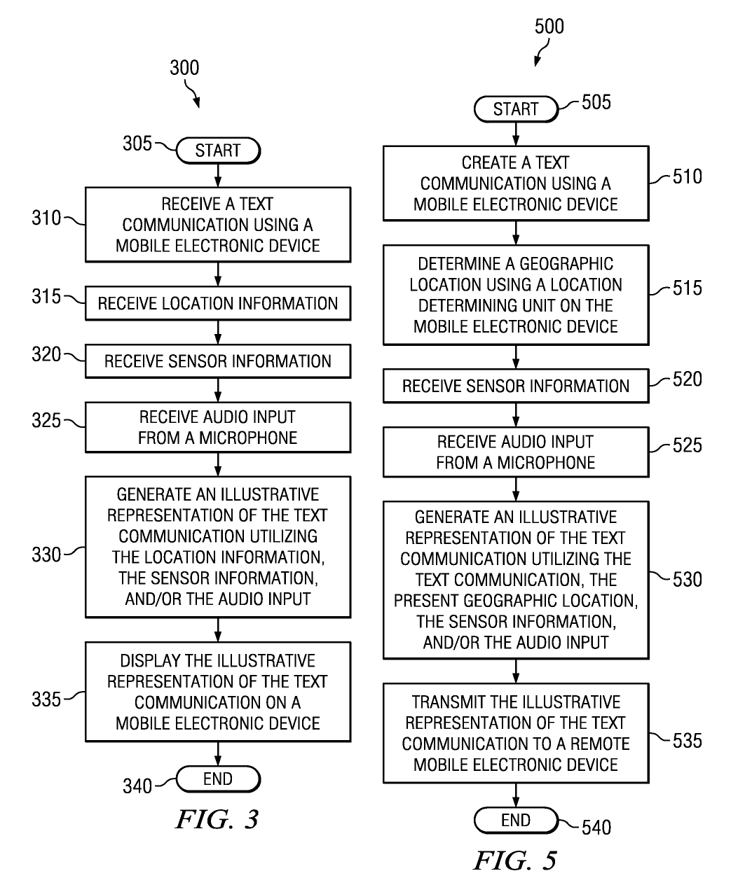

FIG. 3 is a flow diagram illustrating a method for generating and displaying an illustrative representation of a text communication according to an example embodiment of the invention. At 305, the example method begins. At 310, a text communication is received using a mobile electronic device such as mobile electronic device 160. The text communication may be of any form and may be received using any technique. For example, the text communication may be a text message received using a mobile electronic device utilizing the Short Message Service (SMS) or Multimedia Messaging Service (MMS). The text communication may be an email message received by mobile electronic device 160 from an email server such an as email server utilizing the Simple Mail Transfer Protocol (SMTP). The text communication may be an instant message, for example, from the AOL Instant Messenger distributed by AOL LLC or from the Yahoo Messenger distributed by Yahoo!®. At 315, location information is received by a location determining unit such as location determining unit 244 of FIG. 2. The location information may identify any particular geographic location using any technique. For example, the location information may comprise GPS position information and/or a cell identification identifying the location of mobile electronic device 160. In example embodiment, the location information may identify the location of a remote mobile electronic device such as a remote electronic device used by a text communication participant. At 320, sensor information is received. Sensor information may be provided by one or more sensors such as array of sensors 246 located on mobile electronic device 160. Sensor information may represent an output of a sensor of any type including but not limited to a motion sensor such as an accelerometer or a rotation sensor, a light sensor such as a sun light sensor, a camera, environmental sensors such as a temperature sensor or barometer and/or the like. At 325, audio input is received from a microphone such as microphone 226 of FIG. 2. Audio input may comprise any sound received by microphone 226 such as a siren sound of a passing ambulance within proximity of mobile electronic device 160. In another example, audio input may comprise sounds from music playing within proximity of mobile electronic device 160 such as rock music from an electric guitar.

At 330, an illustrative representation of the text communication is generated by a processor, such as processor 220 of FIG. 2 utilizing location information, sensor information, audio input and/or the text communication itself. The illustrative representation of the text communication may comprise images, graphic art, photos, animation, maps, web pages, web links, videos and/or the like which may describe, characterize, explain, exemplify, and/or depict the text communication in any manner. In an example embodiment, the illustrative representation is a comic representation of the text communication. In an example embodiment, comic representation may be any graphic, image and/or the like intended to be humorous and/or visually engaging. Processor 220 may generate an illustrative representation of the text communication by parsing and analyzing the text communication to determine one or more subject matters. For example, a subject matter determined from the text communication may be any person, place or thing mentioned directly in the text communication or that which may be inferred from the text communication. Subject matters of the text communication may also be determined from information obtained from array of sensors 246 solely or in combination with the text communication and/or location information received by location determining unit 244. For example, one sensor of array of sensors 246 on mobile electronic device 160 may be a thermometer, which measures air temperature. The text communication may indicate that it is a warm day outside and location determining unit 246 may confirm a geographic location of mobile electronic device 160 indicating that the mobile electronic device 160 is outdoors. Further, a temperature sensor located on the mobile electronic device 160 may indicate the current temperature and an internal clock may indicate the present time is during the day. Processor 220 may include an illustrative graphic of a sunny sky with the text communication and include the current temperature in Fahrenheit, for example, if the location determining unit 244 has determined that the current location of a mobile electronic device 160 is in Palo Alto, Calif., USA. In an example embodiment, a microphone such as microphone 226 on mobile electronic device 160 may record background noise and processor 220 may include an appropriate image into the illustrative representation to provide further context for the text communication. At 335, the illustrative representation of the text communication is displayed on mobile electronic device 160. The illustrative representation may comprise an image of one or more text communication participants, a visual representation of a least one location, and at least a portion of the text communication. The example method ends at 340.

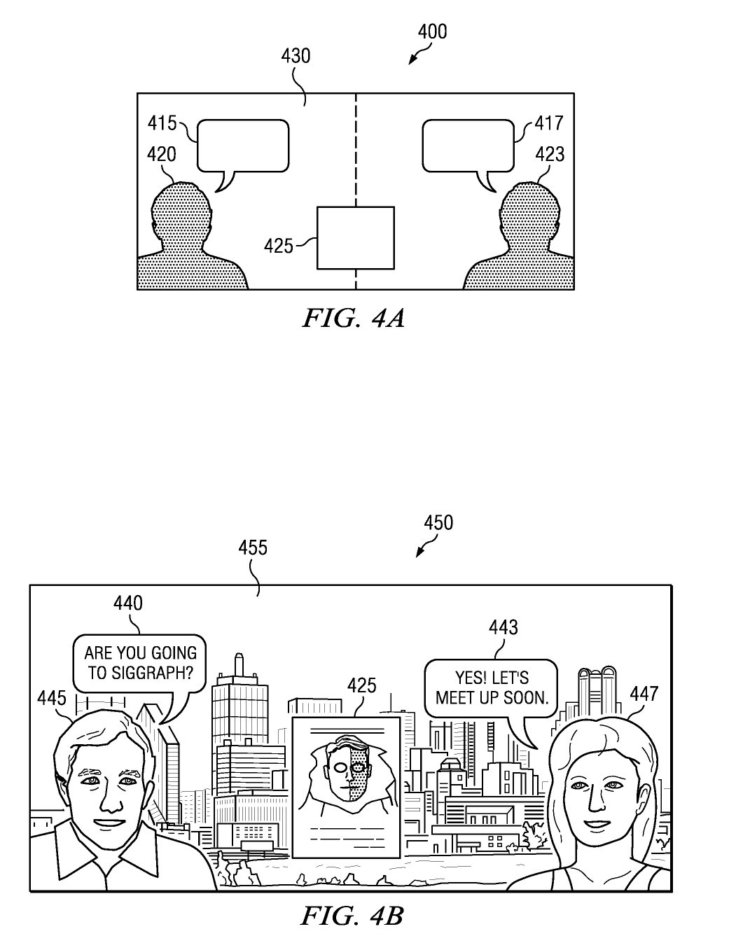

FIG. 4A is a screen view showing a layout 400 of an illustrative representation of a text communication according to an example embodiment of the invention. Layout 400 may comprise one or more text communication participants, such as text communication participant 420 and 423. Layout 400 may also comprise one or more text communication participant dialog areas such as dialog areas 415 and 417. Text communication participants 420 may be represented in any manner such as an image, an Avatar, a caricature and/or the like. Also, a subject matter 425 of the text communication may be shown. Further, the illustrative representation of the text communication may include a graphical, pictorial or other representation of one or more locations. For example, layout 400 indicates an area for a representation of one or more text communication participant locations 430. In an example embodiment, the representation of a location in the illustrative representation of the text communication may be determined from the text communication.

FIG. 4B is a screen view 450 showing an illustrative representation of a text communication as rendered by a processor according to an example embodiment of the invention. Screen view 450 depicts a text communication between text communication participants 445 and 447. In screen view 450, text communication participant 445 states, “Are you going to Siggraph?” and text communication participant 447 responds with “Yes! Let's meet up soon.” Processor 220 of FIG. 2 parses the text communication, determines that a subject matter of the text communication is Siggraph and includes subject matter 425 depicting a graphic of an advertisement for Siggraph 2007. Processor 220 of FIG. 2 may obtain subject matter 425 from any source including a volatile memory such as volatile memory 240 of FIG. 2 or a non-volatile memory such as non-volatile memory 242 of FIG. 2. Further, processor 220 may obtain subject matter 425 from a server on any network including the Internet 120 such as server 130 of FIG. 1. Further, processor 220 includes background image 455 of San Diego, Calif. depicting the location of text communication participants 445 and 447. Location information of the text communication participants may be obtained from a location determining unit such as location determining unit 244. Further, the illustrative representation may incorporate time as a visual element of context. For example, if the message is sent from San Francisco, Calif., USA at 8:00 p.m. local time, processor may incorporate a night view of the San Francisco skyline into the illustrative representation.

FIG. 4C is a screen view 460 showing an illustrative representation of a text communication as rendered by a processor indicating movement of a text communication participant according to an example embodiment of the invention. In screen view 460, a text communication participant 462 states, “Out of battery?” indicating to text communication participant 464 that his mobile electronic device may be low on battery power. In FIG. 4C, text communication participant 464 is depicted using a blurred image to indicate that he is in transit. Based on any indication of movement of one or more text communication participants as indicated by location determining unit 244, one or more sensors in array of sensors 246, and/or the text communication itself, an illustrative representation of motion may be depicted as in the depiction of text communication participant 464. A representation of motion may be depicted in an illustrative representation of a text communication in any manner including but not limited to using motion blurring of an image as in illustrative representation 460, onion skinning, or using a steering wheel to indicate that the text communication participant is in transit such as in FIG. 4D. In an example embodiment, onion skinning is depicting an image with vertical or horizontal lines passing through the image to illustrate that the subject of the image is in motion.

FIG. 4D is a screen view showing an illustrative representation of a text communication as rendered by a processor showing that a text communication participant is travelling in an automobile according to an example embodiment of the invention. Illustrative representation 470 depicts one text communication participant stating in a text communication, “Get milk please”. In an example embodiment, a processor such as processor 220 of FIG. 2 includes a steering wheel 465 in illustrative representation 470 to indicate that text communication participant 468 is travelling in an automobile. Processor 220 may determine that a text communication participant may be traveling in an automobile by analyzing location information from a location determining unit such as location determining unit 244. Further, in FIG. 4D, illustrative representation 470 depicts a siren sound 475 originating from the vicinity of a mobile electronic device of text communication participant 468. Processor 220 may analyze an audio signal received from microphone 226 located on mobile electronic device 160 and determine that the audio is from a siren such as a siren on an ambulance.

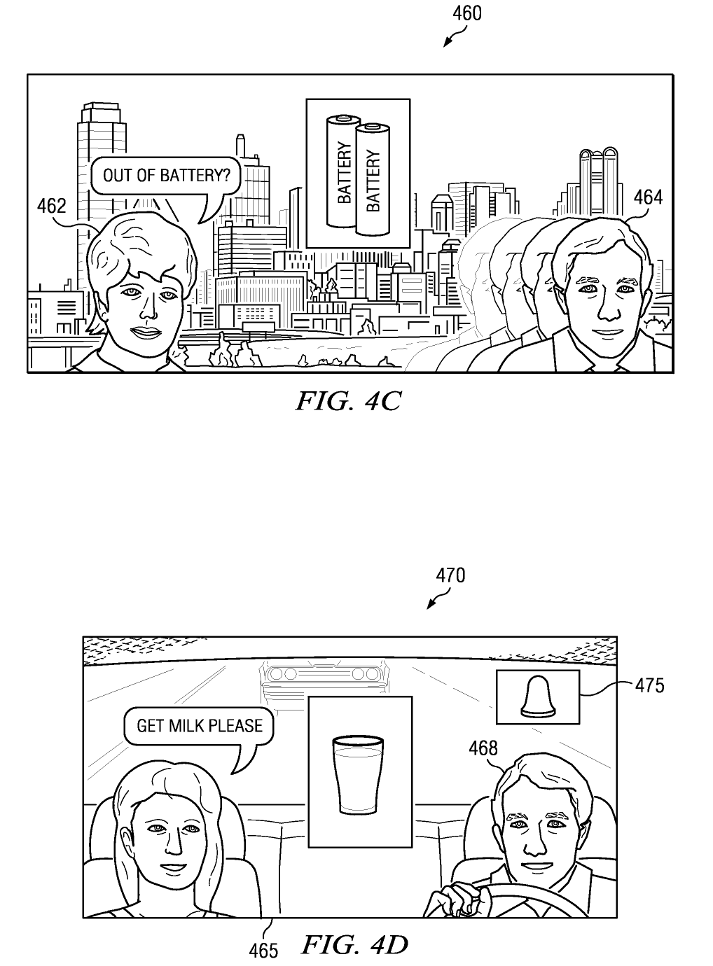

FIG. 5 is a flow diagram illustrating a method 500 for generating and transmitting an illustrative representation of a text communication according to an example embodiment of the invention. At 505, the method begins. At 510, a text communication is created using a mobile electronic device, such as mobile electronic device 160. The text communication may be of any form and may be created using any technique such as a text editor or word processing application on a mobile electronic device. For example, the text communication may be a text message created for the Short Message Service (SMS) or Multimedia Messaging Service (MMS). The text communication may be an email message intended to be transmitted to an email server utilizing the Simple Mail Transfer Protocol (SMTP). Further, the text communication may be an instant message, for example, created using an instant message editor such as the editor included with the AOL Instant Messenger or the Yahoo!® Messenger. At 515, a present geographic location is determined using a location determining unit such as location determining unit 244 on mobile electronic device 160 of FIG. 1. In one example embodiment, location determining unit 244 is a GPS receiver on mobile electronic device 160. In another example embodiment, a present geographic location is determined using cell identification. At 520, sensor information is received by mobile electronic device 160. Sensor information may be provided by one or more sensors such as array of sensors 246 located on mobile electronic device 160. Sensor information may represent an output of a sensor of any type including but not limited to a motion sensor such as an accelerometer or a rotation sensor, light sensors such as a sun light sensor, a camera, environmental sensors such as a temperature sensor or barometer and/or the like. At 525, audio input is received from a microphone such as microphone 226 of FIG. 2. Audio input may be received from any mobile electronic device participating in the text communication.

At 530, an illustrative representation of the text communication is generated by a processor such as processor 220 of FIG. 2 utilizing sensor information, a present geographic location, audio input and/or the text communication from a mobile electronic device. In an example embodiment, illustrative representation of the text communication may comprise images, graphic art, photos, videos and/or the like which may describe, characterize, explain, exemplify, and/or depict the text communication in any manner. In an example embodiment, the illustrative representation is a comic representation of the text communication. Processor 220 may generate an illustrative representation of the text communication by parsing and analyzing the text communication to determine one or more subject matters. At 535, the illustrative representation of the text communication is transmitted by mobile electronic device 160 to a remote mobile electronic device. The illustrative representation may comprise an image of a text communication participant, a representation of a least one location including the present location as determined by a location determining unit such as location determining unit 244 of FIG. 2, visual representation of audio input such as audio input received from a microphone such as microphone 226 of FIG. 2 and at least a portion of the text communication. The method ends at 540.

Without in any way limiting the scope, interpretation, or application of the claims appearing below, a technical effect of one or more of the example embodiments disclosed herein may be to provide an illustrative representation of a text communication to enhance the quality of the text communication and provide meaningful context and location information for the text communication participants.

Embodiments of the present invention may be implemented in software, hardware, application logic or a combination of software, hardware and application logic. The software, application logic and/or hardware may reside on any volatile such as a random access memory or non-volatile memory such as an electrically erasable programmable read-only memory (EEPROM). In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method comprising:
receiving a text communication using a mobile electronic device;
receiving location information;
generating an illustrative representation of said text communication utilizing said text communication and said location information; and
displaying said illustrative representation,
said illustrative representation of said text communication comprises:
a visual representation of at least one text communication participant,
a visual representation of at least one location, and
at least a portion of said text communication.

2. A method according to claim 1, wherein said illustrative representation further comprises a visual representation of at least one subject matter related to said text communication.

3. A method according to claim 1, wherein said location information is obtained via a location determining unit on said mobile electronic device.

4. A method according to claim 1, wherein said illustrative representation of said text communication indicates movement of said at least one text communication participant.

5. A method according to claim 1, further comprising receiving audio input from a microphone on said mobile electronic device and wherein said generating an illustrative representation further comprises utilizing said audio input.

6. A method according to claim 1, further comprising receiving sensor information from at least one sensor on said mobile electronic device and wherein said generating an illustrative representation further comprises utilizing said sensor information.

7. A method according to claim 6, wherein said sensor information comprises data related to an accelerometer on said mobile electronic device.

8. A method according to claim 6, wherein said sensor information comprises data related to an environmental sensor on said mobile electronic device.

9. A method comprising:
creating a text communication using a mobile electronic device;
determining a geographic location using a location determining unit on said mobile electronic device;
generating an illustrative representation of said text communication utilizing said text communication and said geographic location; and
transmitting said illustrative representation to a remote mobile electronic device,
said illustrative representation of said text communication comprises:
a visual representation of at least one text communication participant,
a visual representation of said present geographic location, and
at least a portion of said text communication.

10. A method according to claim 9, wherein said illustrative representation further comprises a visual representation of a subject matter related to said text communication.

11. A method according to claim 9, further comprising receiving sensor information from at least one sensor on said mobile electronic device and wherein generating an illustrative representation further comprises utilizing said sensor information.

12. An apparatus comprising:
a network interface for receiving a text communication;
a location determining unit;
at least one sensor;
a processor communicatively coupled with said network interface, said location determining unit and said at least one sensor, said processor configured to generate an illustrative representation of said text communication, said generation utilizing output from said location determining unit and said at least one sensor; and
a display configured to display said illustrative representation of said text communication,
said illustrative representation of said text communication comprises:
a visual representation of a text communication participant,
a visual representation of at least one location, and
at least a portion of said text communication.

13. An apparatus according to claim 12, wherein said apparatus is a mobile electronic device.

14. An apparatus according to claim 13, wherein said visual representation of a text communication participant comprises an Avatar.

15. An apparatus according to claim 12, wherein said at least one sensor comprises an accelerometer.

16. An apparatus according to claim 12, wherein said at least one sensor comprises a rotation sensor.

17. An apparatus according to claim 12, further comprising a microphone for receiving audio input communicatively coupled with said processor.

18. A computer program product comprising a computer-readable medium bearing computer program code embodied therein for use with a computer, the computer program code comprising:
code for receiving a text communication;
code for receiving location information;
code for receiving sensor information;
code for generating an illustrative representation of said text communication utilizing said sensor information and said location information; and
code for displaying said illustrative representation,
said illustrative representation of said text communication comprises
a visual representation of a text communication participant,
a visual representation of at least one location, and
at least a portion of said text communication.

19. A computer program product according to claim 18, wherein said illustrative representation of said text communication further comprises a visual representation of a subject matter related to said text communication.

20. A computer program according to claim 18, wherein said illustrative representation of said text communication indicates movement of said text communication participant.

21-25. (canceled)
